(19) United States
(12) Patent Application Publication
(10) Pub. No.: US 2010/0008081 A1
(43) Pub. Date: Jan. 14, 2010

(54) Light for illuminating plants

(76) Inventors: Serafino Canino, Torrington, CT (US); Scott Gelormino, Burlington, CT (US)

Correspondence Address: THOMPSON HINE L.L.P.;Intellectual Property Group, P.O. BOX 8801, DAYTON, OH, 45401-8801, US

(21) Appl. No.: 12/330,390

(22) Filed: Dec. 8, 2008

Related U.S. Application Data
(63) Continuation-in-part of application No. 12/169,623, filed on Jul. 8, 2008.

(51) Int. Cl. F21L 4/00; F21V 15/01; F21L 4/08; F21V 99/00

(52) U.S. Cl. 362/191; 362/368; 362/192; 362/351

(57) ABSTRACT

Apparatus for illuminating a plant comprising an elongated support member and a housing mounted on a elongated support member is disclosed. A light is mounted on the housing. A control turns the light on or off and/or otherwise controls the light. Coupling structure on the elongated support member and mating coupling structure on the housing is included. The mating coupling structure mating with the coupling structure on the housing allows the elongated support member to be detachably attached to the housing.

### CROSS REFERENCE TO RELATED APPLICATIONS

This application is a Continuation-in-Part of application Ser. No. 12/169,623 entitled “LONG LIFE CRANKING MINIMIZED FLASHLIGHT” which is hereby incorporated herein by reference and a Continuation-in-Part of application Ser. No. 12/236,501, entitled “LIGHT FOR ILLUMINATING PLANTS” filed Sep. 24, 2008 as a non provisional but which is being converted to a provisional application.

### TECHNICAL FIELD

The invention relates to devices for illuminating plants in pots, plantings and the like.

### STATEMENT REGARDING FEDERALLY SPONSORED RESEARCH OR DEVELOPMENT

(Not applicable)

### BACKGROUND OF THE INVENTION

Plants lend a vibrant, relaxing and natural atmosphere to a space, whether it is indoor or outdoor. In the case of indoor plants, the same also have the good effect of increasing oxygen and humidity in the air. Plants may also trap some air pollutants, rendering even further healthful effects.

Certainly another one of the advantages of plants is the fact that they may be seen and, when seen, have the effect of psychologically relaxing people, as well as lending beauty and ambience to the space in which they are located.

However, modern lifestyles often mean work for long hours and arrival at home long after the sun has fallen. Thus, plants are not likely in many cases to be seen unless they are illuminated. However, given increasing fuel costs (which, in recent memory goes back certainly as far back as the early 1970s), environmental reasons to reduce consumption of electricity, and so forth, lights put on at night in a space may be task oriented, such as desk lamps, or event oriented, such as a lamp on a coffee table which will only illuminate the area surrounded by a group of people talking, for example, at a cocktail party. There are also other circumstances which may restrict the amount of light available in the space, such as a room or patio, and these may include, for example, low levels of lighting used for economical reasons or to create a certain mood, and sometimes low levels of lighting associated, for example, with colored lights also intended to create a mood.

Accordingly, plants located on a windowsill, for example, may not be sufficiently illuminated to be visible when lights in a room are turned on. Likewise, plants located in outdoor planting beds proximate to, for example, an open or closed patio, are not likely to be illuminated by general lighting.

On another note, the dramatic effect of illuminated plants is apparent. Accordingly, it would be desirable to provide independent function-oriented lights for illuminating plants in indoor and outdoor spaces.

### SUMMARY OF THE INVENTION

In accordance with the invention, apparatus for illuminating a plant comprises an elongated support member and a housing mounted on the elongated support member. A light is mounted on the housing. A control turns the light on or off and/or otherwise controls the light.

Coupling structure is located on the elongated support member and mating coupling structure is located on the housing. The mating coupling structure mates with the coupling structure on the housing allows the elongated support member to be detachably attached to the housing.

The housing may support a solar cell.

The light may be powered by a rechargeable battery. A circuit prevents the light from going on unless the rechargeable battery meets a minimum performance criteria.

A generator may be used to charge a rechargeable battery for powering the light.

Optionally the light output by the plant light may vary from one light color to another.

The light may be powered for a fixed period of time after the control is actuated.

The housing may be configured for ergonomic use as a flashlight when the elongated support is detached.

In accordance with the invention, optics may be provided for variably controlling light output from the light to achieve a desired illumination pattern.

The control may optionally turn on the light in response to ambient light dropping below a predefined level.

### BRIEF DESCRIPTION THE DRAWINGS

The operation of the invention will become apparent from the following description taken in conjunction with the drawings, in which:

FIG. 1 illustrates a general implementation of the plant light of the present invention;

FIG. 2 shows the inventive plant light illuminating a plant in a pot;

FIG. 3 illustrates a plant light of the present invention in a configuration to be used as a flashlight;

FIG. 4 illustrates a spike which may be unscrewed to convert the plant light into a flashlight according to the present invention;

FIG. 5 is a schematic diagram of the inventive flashlight illustrated in FIGS. 1-4;

FIG. 6 is a front view of an alternative embodiment of the inventive flashlight;

FIG. 7 is a rear view of the embodiment of the inventive flashlight illustrated in FIG. 6;

FIG. 8 is a block diagram illustrating the plant light of FIGS. 6-7 of the present invention;

FIG. 9 is a block diagram of another alternative embodiment of the invention;

FIG. 10 is a block diagram of still another alternative embodiment of the invention;

FIG. 11 illustrates the plant light of FIG. 10 in use; and

FIG. 12 illustrates the placement of parts in the embodiment of the invention illustrated in FIGS. 10-11.

### DETAILED DESCRIPTION OF THE PREFERRED EMBODIMENTS

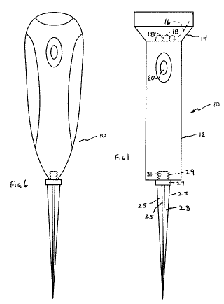

Referring to FIG. 1, the inventive plant light 10 comprises a housing 12 which houses the components of the inventive plant light 10. Housing 12 supports an optics housing 14. Optics housing 14 houses a reflector 16 and a light source 18. Light source 18 may be a light emitting diode. As illustrated in FIG. 1, reflector 16 serves the purpose of concentrating the output of light emitting diode 18. Alternatively, or in addition, a lens may be used to cooperate with reflector 16.

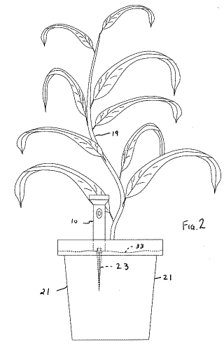

In accordance with the invention, optics housing 14 may be located to perform a focusing function in which the position of the focal point of the optics concentrating the output of light source 18 is varied with respect to light source 18, resulting in the light coming to a focus at varying distances from light source 18. This also has the consequence of varying the width of the bundle of illumination which outputs housing 14 at varying distances from the inventive plant light 10. Accordingly, the light may be concentrated to illuminate a desired portion of, for example, a plant 19 in a pot 21, as illustrated in FIG. 2. Control of the lighting may be achieved by adjustment of the focusing optics and/or orientation of the plant light 10, as more fully appears below.

Other light concentrating structures may be used, such as those illustrated in U.S. Pat. No. 6,959,999 directed to a flashlight having a manual charging device, the disclosure of which is hereby incorporated into this specification by reference. Single lenses, multiple lenses, single reflectors, multiple reflectors and the like may be employed.

Inventive plant light 10 also comprises a pushbutton actuator 20. Pushbutton actuator 20 may be a simple single pole-single throw on-off electrical switch, or it may be of more complex structure and incorporates other functions, such as timing, number of lights illuminated, etc.

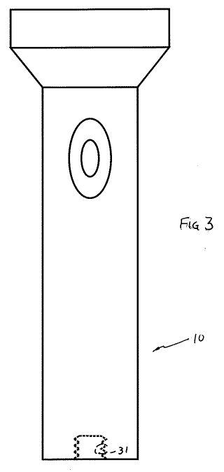

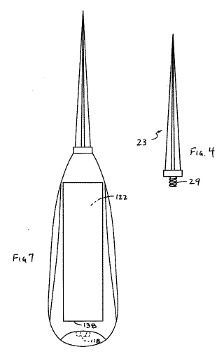

In accordance with the invention, plant light 10 comprises a spike 23 formed of four tangs 25, of conventional design. Tangs 25 extend from a base 27. Base 27 supports a threaded member 29 which screws into a tapped hole 31 in housing 12. This permits plant light 10 to be unscrewed from spike 23 and used as a flashlight, as illustrated in FIG. 3. Spike 23 (FIG. 4) may then be stored when it is desired to again use plant light 10 to illuminate a plant. At that time, spike 23 may then be screwed into tapped hole 31 by threaded member 29.

Spike 23 allows plant light 10 to be supported in earth 33, contained in pot 21, at any desired angle as illustrated in phantom lines in FIG. 2. This, together with the other adjustments provided in accordance with the invention, as detailed herein, such as the adjustment of lighting bundle width and color, provide for a significant measure of flexibility in lighting plants using the inventive plant light 10.

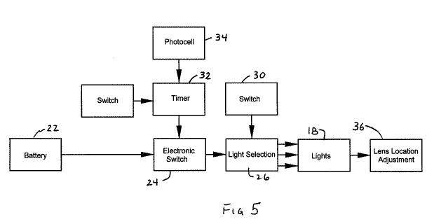

The operation of a preferred embodiment of the inventive plant light may be seen with reference to FIG. 5. FIG. 5 is a schematic diagram of the inventive plant light. More particularly, power is supplied by a battery 22 which is coupled to an electronic switch 24. Electronic switch 24 provides power to a light selection circuit 26 which determines when and how power will be applied to one or more lights 18. This is selected by the user by operating switch 30.

In accordance with the invention, it is also possible to have a plurality of lights, each of a different color. The user would then be able to select the color of light with which he wishes to illuminate the plant 19. Still yet another alternative is for the color of the lights to be varied as is done in the prior art, for example each light varying in intensity over time, causing the output light from the device to vary in color, and cycle through, for example, the colors of the rainbow, or between two or three different colors.

In accordance with the invention, intensity alone may simply be varied by varying the number of lights which are provided with power by light selection circuit 26.

Another feature of the invention is to optionally minimize the drainage of battery 22 during use. For example, when switch 20 is actuated, it may trigger a timer 32, causing timer 32 to turn on electronic switch 24 for a fixed period of time, for example, three hours, or some other period of time which would be typical of an evening spent alone or as part of a group in a room. The result is to conserve the electrical power in battery 22, as well as to extend the life of battery 22, particularly important in the event that it is a rechargeable battery.

In accordance with the invention, the provision of power to light or lights 18 may be triggered by a photocell 34 which produces a small electrical signal in ambient light during the day, and when the sun goes down produces a smaller or no electrical signal, resulting in the triggering of timer 32 which causes the inventive plant light to output light for a fixed period of time. Such an embodiment of the present invention would be of particular value to a plant light 10 which is to be placed underneath a plant in a garden, and where the user wants the plant to be illuminated after darkness. Again the provision of timer 32 results in conservation of battery 22.

As discussed above, in accordance with the invention, a focusing mechanism 36 to provide lens adjustment and variation of the size of the illuminating beam output from the inventive plant light 10 is provided.

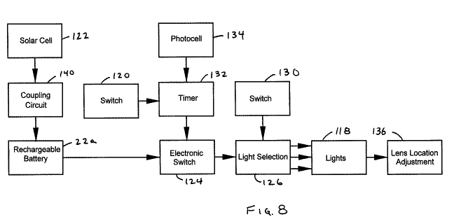

In accordance with one embodiment of the invention, an alternative embodiment of the inventive plant light 110 may incorporate a solar battery 122 as illustrated in FIGS. 6-7. Battery 122 may be covered with a transparent face 138 to protect the solar battery 122 from the elements. As may be seen from FIG. 7, solar battery 122 takes up most of the top of flashlight 110, barely leaving room for light sources 118. This maximizes the area for solar power generation.

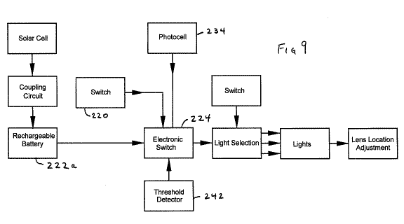

The operation of plant light 110 illustrated in FIGS. 6 and 7 may be understood with reference to the schematic diagram of FIG. 8. Generally, the operation of plant light 110 is substantially the same as that of the operation of plant light 10, except where indicated as different herein. In the various embodiments herein, to the extent practical, parts have been numbered, with numbers which are multiples of 100 different from those of the embodiment of FIGS. 1-5 where function and/or structure of those parts is similar or analogous.

Solar power is provided by solar cell 122. Coupling circuit 140 couples the output of solar cell 122 to a rechargeable battery 22a. Coupling circuit 140 is of conventional design, for example, ensuring proper charging and preventing against undue discharge of rechargeable battery 22a.

By the closure of switch 120, or the output of photocell circuit 134 reaching a threshold value, timer 132 is caused to activate electronic switch 124 to pass power to light selection switch 126. The passage of power through light selection circuit 126 is under control of switch 130, and occurs substantially in the manner described above in connection with the embodiment of FIG. 5. Lights 118 are then illuminated and depending upon the adjustment of the focusing mechanism 136, a desired portion of a plant, or other object for that matter, is illuminated in accordance with the invention.

In accordance with the invention, it is contemplated that a plant in a pot will be located in a window thus providing for light coming from the direction of the window. Accordingly, the solar powered plant light of FIGS. 6-8 is probably oriented with solar cell 122 facing the window. In the case of the inventive plant light being used outdoors, solar cell 122 is usually best faced somewhat upwardly and in a general southerly direction to maximize the collection of available sunlight. Of course, depending upon other objects, time of year, and so forth, the position of the light may be varied. Generally, the light is oriented to face generally toward the sun available for the longest period of time with the highest intensity, corresponding to the highest output of energy.

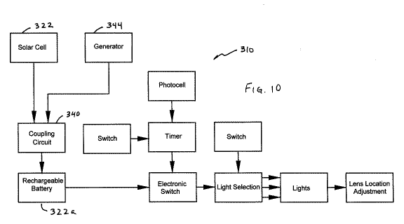

Referring to FIG. 9, still yet another alternative embodiment of the inventive plant light 210 is illustrated in schematic form. The operation of the circuit of FIG. 9 is substantially identical to that of the circuit of FIG. 8, except that while electronic switch 224 is responsive to switch 220 and photocell 234 in the manner described above, electronic switch 224 will not turn on the light unless threshold detector 242 determines that the voltage across rechargeable battery 222a is above a certain threshold. Generally, rechargeable batteries are likely to be damaged if their voltage is allowed to drop below a threshold value, and thus threshold detector 242 prevents the damage of the battery due to too deep a discharge.

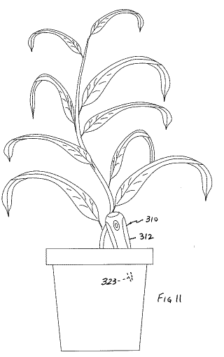

In accordance with the invention, as illustrated in FIG. 10, inventive plant light 310 may comprise a rechargeable battery 322a in a circuit much like that illustrated in FIG. 8, except that the system further includes a generator 344. Generator 344, together with a solar cell 322 is coupled by coupling circuit 340 to rechargeable battery 322a. In accordance with this embodiment, a mechanically driven generator, for example a generator driven by a crank used to recharge rechargeable battery 322a in the absence of sunlight falling on solar cell 322.

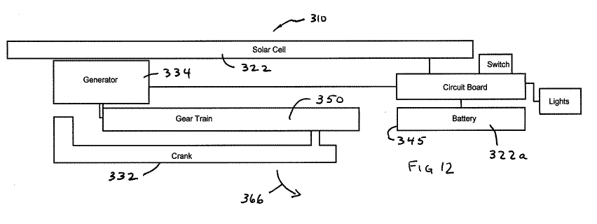

The detachable flashlight portion of solar and crank-rechargeable plant light 310 may take the form of a flashlight as is disclosed in my co-pending U.S. patent application Ser. No. 12/169,623 directed to Long Life Cranking Minimized Flashlight (the disclosure of which is incorporated herein by reference), as is illustrated in FIG. 11. It is also contemplated that plant light 310 may be spike mounted in the soil contained within a pot 321 through the use of a spike 323.

Referring to FIG. 12, the layout and general proportions of the parts of alternative inventive plant light 310 are illustrated schematically. In this embodiment, the convention used above of numbering analogous parts with numbers separated from analogous parts in other embodiments by multiples of a hundred has been followed. Multiple functions are reflected by multiple designations in the drawings. FIG. 12 generally shows a mechanical layout of the parts schematically to result in easy access to the battery and easy cranking using a crank 332. The layout of FIG. 12 has the advantage of allowing one side to be substantially covered only by the solar cell. The design is thus, at once, ergonomic to hold, ergonomic to crank and involves an efficient use of space. At the same time, it allows a crank 332 to be placed substantially in the center of the bottom of the plant light 310, allowing placement of a battery receiving compartment 345 in a position which allows easy replacement of the battery when it wears out and no longer takes a sufficient charge in the estimation of the user.

Charging of battery 322a by generator 334 and solar cell 322 is done through coupling circuit 340 which is located on the same circuit board as electronic switch 324 and timer 332, as illustrated in FIG. 12. Likewise, switches 320 and 330 may be put in a common position, side by side or arranged in some other fashion. Actuation of lights may be controlled switches 320 and 330 acting through circuit board 324, 332, 340.

Charging is achieved by the cranking of a crank 332, in a manner detailed in my co-pending application referenced above. This results in applying a rotary mechanical input to a gear train 350 (FIG. 12).

Gear train 350 comprises a number of gears, as illustrated and detailed in the above referenced application which is incorporated by reference.

When it is desired to charge the inventive flashlight, crank 332 is rotated outwardly in the direction of arrow 366, until it may be cranked to turn generator 344. Such rotation is begun and is continued until crank 332 is substantially parallel to the housing 312 of plant light 310, allowing easy cranking.

While an illustrative embodiment of the invention has been described, it is understood that modifications will be obvious to those of ordinary skill in the art. Such modifications are within the spirit and scope of the invention which is limited and defined only by the appended claims.

What is claimed is:

1. Apparatus for illuminating a plant, comprising:
(a) an elongated support member;
(b) a housing mounted on said elongated support member;
(c) a light mounted on said housing; and
(d) a control for turning said light on or off and/or otherwise controlling said light.

2. Apparatus as in claim 1, further comprising:
(e) coupling structure on said elongated support member; and
(f) mating coupling structure on said housing, said mating coupling structure mating with said coupling structure on said housing, allowing said elongated support member to be detachably attached to said housing.

3. Apparatus as in claim 2, wherein said housing supports a solar cell.

4. Apparatus as in claim 1, wherein said light is powered by a rechargeable battery, and further comprising circuit structure for preventing said light from going on unless said rechargeable battery meets at a minimum performance criteria.

5. Apparatus as in claim 1, further comprising a generator for charging a rechargeable battery for powering said light.

6. Apparatus as in claim 1, wherein said light varies from one light color to another.

7. Apparatus as in claim 1, wherein said light is powered for a fixed period of time after said control is actuated.

8. Apparatus as in claim 1, wherein said housing is configured for ergonomic use as a flashlight when said elongated support is detached.

9. Apparatus as in claim 1, further comprising optics for variably controlling light output from said light to achieve a desired illumination pattern.

10. Apparatus as in claim 1 wherein said control turns on said light in response to ambient light dropping below a predefined level.
